(19) United States
(12) Patent Application Publication
(10) Pub. No.: US 2026/0284925 A1
(43) Pub. Date: Sep. 24, 2026

(54) SHAPING TOOL AND METHOD OF SHAPING A WORKPIECE

(71) Applicant: Zeeko Innovations Limited, Coalville (GB)

(72) Inventors: Anthony Tadeus Beaucamp, Saitama (JP); Ashwani Pratap, Coalville (GB)

(73) Assignee: Zeeko Innovations Limited, Coalville, LE (GB)

(21) Appl. No.: 19/474,551

(22) PCT Filed: Apr. 10, 2024
(86) PCT No.: PCT/GB2024/050940

§ 371 Date: Oct. 10, 2025

(30) Foreign Application Priority Data
Apr. 13, 2023 (GB) 2305440.6

(51) Int. Cl. B27B 29/00; B24B 27/00

(52) U.S. Cl. CPC B27B 29/00; B24B 27/0076

(57) ABSTRACT

A shaping tool for shaping and polishing a workpiece. The shaping tool comprises a rigid shaping part for shaping the workpiece in use by movement of an outwardly facing surface of the rigid shaping part and a surface of the workpiece against each other so as to remove material from at least a part of the workpiece; and a polishing surface biasable towards a first position in which said polishing surface protrudes relative to an adjacent region of the outwardly facing surface of the rigid shaping part, wherein the polishing surface is moveable to a second position in which the polishing surface lies level with said adjacent region of the outwardly facing surface of the rigid shaping part. When the shaping tool is applied to a workpiece to remove material therefrom and polish the workpiece, the polishing surface, while moving against that part of the workpiece, is biased towards the first position so as to contact the part of the workpiece from which material was removed by the rigid shaping part thereby polishing that part of the workpiece.

### FIELD OF THE INVENTION

This invention relates to a tool for shaping and polishing workpieces. Tools in accordance with embodiments of this invention are suitable for use in the manufacture of a wide variety of components such as lenses, semiconductor wafers and prosthetics. The invention also provides methods of shaping a workpiece.

### BACKGROUND

Manufacturing components with smooth finishes is a requirement in many industries. Examples of components that need to be shaped and smoothed are optical components including lenses and mirrors, prosthetics, and semiconductor wafers. Typically the manufacture of these components involves a multi-step process in which the component is shaped from an initial workpiece (e.g. by grinding, milling or turning) and then, through successive polishing steps, polished to an increasingly smooth finish. Each step generally involves treating the workpiece with a different tool capable of providing a successively smoother finish, which is necessary for reducing the roughness of the surface to the required level but makes the manufacturing process complex and time-consuming.

Recently, the advent of fine grinding processes such as Shape Adaptive Grinding (SAG) techniques has improved the speed of manufacturing some shaped components since processes of this kind achieve both high rates of material removal and a high degree of smoothness. Examples of SAG tools and processes are described in detail in WO2016/051121A1. Despite the advantages of SAG, these techniques are typically still incorporated as part of a multi-step process involving multiple tools and therefore suffer limited throughput and a degree of complexity. There is therefore a need to simplify and improve the speed of component manufacture further.

### SUMMARY OF THE INVENTION

A first aspect of the invention provides a shaping tool for shaping and polishing a workpiece, the shaping tool comprising:

a rigid shaping part for shaping the workpiece in use by movement of an outwardly facing surface of the rigid shaping part and a surface of the workpiece against each other so as to remove material from at least a part of the workpiece; and a polishing surface biasable towards a first position in which said polishing surface protrudes relative to an adjacent region of the outwardly facing surface of the rigid shaping part, wherein the polishing surface is moveable to a second position in which the polishing surface lies level with said adjacent region of the outwardly facing surface of the rigid shaping part;

whereby, when the shaping tool is applied to a workpiece to remove material therefrom and polish the workpiece, the polishing surface, while moving against that part of the workpiece, is biased towards the first position so as to contact the part of the workpiece from which material was removed by the rigid shaping part thereby polishing that part of the workpiece.

This tool combines a rigid shaping part, capable of shaping a workpiece by removal of material from the workpiece, and a polishing surface, capable of smoothing the parts of the workpiece shaped by the rigid shaping part, into a single tool. The arrangement of the rigid shaping part and the polishing surface defined above (in which the polishing surface is biasable towards the first position in which it protrudes relative to the adjacent surface of the rigid shaping part) ensures that as the shaping tool moves against the workpiece, at least some of the region of the workpiece shaped by the rigid shaping part is subsequently polishing by the polishing part. Once part of the workpiece has been shaped by removal by the rigid shaping part, the polishing surface which will, at least in use, be biased towards the first position, enabling the polishing surface to remove a thin further layer of extra material from the workpiece, leaving a polished surface. Consequently, two operations (shaping and polishing) that previously needed to be performed in separate operations using different tools may, using the tool defined above, be performed in a single operation. This significantly reduces the time required to manufacture a component from the workpiece, which enables faster and lower-cost production of components.

The tool defined above has been found to achieve a further advantage in that, by providing the polishing surface and rigid shaping part in combination, the polishing surface provides a damping effect against vibrations of the rigid shaping part, which reduces chatter between the rigid shaping part and the workpiece. Chatter—i.e. vibration of a tool against the workpiece being shaped—can be a significant problem in shaping operations using rigid tools, in particular grinding and cutting, so the presence of the polishing surface achieves an improvement in the quality of the shaping, even before any polishing has taken place.

The movement of the outwardly facing surface of the rigid shaping component and the workpiece against one another will most typically be achieved by rotation of the shaping tool about a rotational axis thereof, as will be shown with reference to several examples. In principle, however, the shaping tool could be configured for any other way of generating relative movement between the workpiece and the rigid shaping part while in contact with one another, for example rotation of the workpiece while the tool is held stationary. Other kinds of motion of the tool, including orbital, eccentric and random motion may be applied in addition, or as alternatives, to the examples just described in methods of use of the tool.

As noted above, the polishing surface is biasable towards a first position in which it protrudes relative to an adjacent region of the outwardly facing surface of the rigid shaping part. The polishing surface is provided in this biasable configuration so that, when the rigid shaping part is in contact with the workpiece, the polishing surface may be biased against the surface and thereby be able to polishing the workpiece surface. Additionally, the polishing surface is moveable to a second position in which it lies level with the adjacent part of the outwardly facing surface, which ensures that the outwardly facing surface of the rigid shaping part can contact the workpiece at the same time as the polishing surface.

In preferred embodiments, the shaping tool further comprises a deformable polishing part comprising the polishing surface, the polishing surface being moveable between the first position and the second position by deformation of the deformable polishing part. The polishing part could for example comprise an elastic member (e.g. a rubber part) arranged such that, when not subject to any deforming forces, the polishing surface occupies the first position. The elastic member in this example would be compressible such that the polishing surface can be moved the second position by compression of the elastic member. Other configurations are possible, however: for example, the polishing surface could be mounted on a moveable piston. The deformable polishing part also further enhances the chatter-reducing effects of the polishing surface described above, since additional damping is achieved through deformation of the polishing part.

In some preferred embodiments, the deformable polishing part comprises a cavity configured to receive, in use, a pressurised fluid for controlling the pressure between the polishing surface and the workpiece. The cavity could be formed by a deformable bladder, on the exterior of which is mounted the polishing surface. The position and biasing force applied to the polishing surface can thus be controlled by varying the amount and/or pressure of the fluid in the cavity.

As noted above, advantageously, the rigid shaping part may be arranged to remove material from the workpiece when, in use, the rigid shaping part is placed in contact with the workpiece and the shaping tool is rotated about a rotational axis thereof. For this purpose the shaping tool could be provided with a spindle whereby the shaping tool may be mounted, in use, in a polishing machine. Preferably the polishing surface is arranged such that, as the shaping tool is rotated about the rotational axis, the polishing surface may, by the rotation of the shaping tool, be brought into contact with the part of the workpiece from which material was removed by the rigid shaping part. This is advantageous as, in this arrangement, the polishing surface and rigid shaping parts may alternately pass over the same part of the workpiece as the tool is rotated. This arrangement therefore ensures that all parts of the workpiece shaped by the rigid shaping part are also polished by the polishing surface.

In some preferred embodiments, the polishing surface is arranged such that, as the shaping tool is translated along a tool path along which it removes material from the workpiece, the polishing surface may, by the translation of the shaping tool along the tool path, be brought into contact with the part of the workpiece from which material was removed by the rigid shaping part. For example, the polishing surface and the outwardly facing surface of the rigid shaping part could be arranged concentrically with one another. This provides a relatively simple construction of the tool.

The rigid shaping part may be configured for shaping the workpiece by grinding, milling or turning.

Preferably, the polishing surface is configured for shape adaptive grinding (SAG). As noted above, the principles of SAG and examples of tools configured for this process are described in WO2016/051121A1. SAG tools generally comprise an elastic part, which is capable of conforming to the shape of the workpiece, and a polishing surface which carries rigid pellets on its surface. The polishing surface being configured for SAG is advantageous as SAG is capable of achieving a smooth finish in a relatively short period of time, which further enhances the ability of the tool to increase the speed of component manufacture.

Advantageously, the polishing surface may comprise a flexible support layer which carries abrasive particles arranged to contact the surface of the workpiece in use. These features may be present in particular where the polishing surface is configured for SAG.

In some preferred embodiments, the polishing surface and said adjacent region of the outwardly facing surface of the rigid shaping part are arranged concentric with one another. As noted above, this provides a simple construction of the tool. Preferably, in these embodiments, said adjacent region of the outwardly facing surface of the rigid shaping part is arranged outward relative to the polishing surface. Where the polishing surface and adjacent region of the outwardly facing surface are concentric, preferably the rigid shaping part is shaped to define an aperture and the polishing surface is arranged such that it protrudes from the aperture when in the first position.

The shaping tool of any preceding claim wherein the polishing surface comprises an aperture arranged such that, when the shaping tool is rotated about an axis extending through the aperture, the entire polishing surface moves, due to the rotation of the tool, at a non-zero velocity. This results in all parts of the polishing surface moving relative to the workpiece surface at at least a minimum speed determined by the diameter of the aperture. This is advantageous as it has been found that, where parts of the polishing surface move slowly (or not at all) across the surface of the workpiece, these parts achieve relatively little polishing but can suffer significant heating, particularly when a fluid (e.g. water) is supplied to cool the area being polishing (since the fluid has difficulty reaching the slow-moving parts of the polishing surface). Omitting the part of the polishing surface through which the rotational axis passes overcomes these problems.

Advantageously, wherein the outwardly facing surface of the rigid shaping part may be shaped to define one or more grooves, wherein the polishing surface protrudes from the one of more grooves when in the first position and lies level with the regions of the outwardly facing surface adjacent to the grooves when in the second position. This is one way in which the polishing surface may be arranged such that each part of the workpiece treated by the rigid shaping part is also treated by the polishing surface.

In preferred implementations, the rigid shaping part comprises one or more cutting elements each comprising a respective cutting edge arranged to remove material from the workpiece when placed in contact with the surface of the workpiece and moved against the surface of the workpiece, the outwardly facing surface comprising the cutting edges of the one or more cutting elements. The term “cutting element” here refers to an element capable of removing material from the workpiece by cutting, as opposed to other modes of material removal such as grinding. Tools incorporating cutting elements of this kind are typically used in milling operations. It will be appreciated that the outwardly facing surface in these implementations, which comprises the cutting edges of the or each cutting element, may not be a single, continuous surface area since the cutting edges will typically be spatially separate from one another but nonetheless form, in combination, a (discontinuous) surface that is capable of removing material from the workpiece in use. It has been found that shaping tools in accordance with these embodiments provide a significant reduction in “chatter” (i.e. vibration or oscillation of the tool relative to the workpiece) in use, particularly in milling operations, which both improves the quality of the surface finish achieved by the tool and prolongs the tool's life. This reduction in chatter is believed to be at least in part due to a damping effect produced by the polishing surface. It is therefore preferred that in these implementations, the polishing surface is comprised by a deformable polishing part as defined above, particularly one that includes an elastic member (e.g. a rubber part) arranged such that, when not subject to any deforming forces, the polishing surface occupies the first position. The polishing part being deformable enhances the damping effect of the polishing surface.

The cutting elements may be removably mounted on a tool body part configured to hold the cutting elements resiliently while removing material from the workpiece. This allows for the cutting elements to be replaced conveniently when worn out. The cutting elements may be milling inserts, for example. Milling inserts are commercially available and are typically made of ceramic or “ceramet” (a class of composite materials in which ceramic particles are bound by a metal binder).

In preferred implementations, the cutting edges of the cutting elements are rounded. This is preferred as rounded cutting elements are particularly suitable for forming curved, irregular and complex shapes.

Preferably, the polishing surface is a three-dimensional surface, preferably comprising a rounded edge region extending circumferentially around a central region of the polishing surface, wherein preferably the central region is substantially flat. By “three-dimensional surface” we mean that the polishing surface does not occupy a single, flat plane—in other words, there are some parts of the surface with different orientations to other parts of the surface. For example, flat, circular disc defines a two-dimensional surface whereas the curved surface of a hemisphere is an example of a three-dimensional surface. A rounded edge region of this kind is advantageous as it is capable of treating curved, irregular and complex workpiece shapes which would be difficult or impossible to polish with a flat tool. In particularly preferred implementations, the rounded edge is shaped to define one or more recessed areas, each cutting element being arranged inside one of the recessed areas such that when the polishing surface is in the second position, the part of the polishing surface adjacent to the recessed area lies level with the cutting edge of the cutting element arranged inside said recessed area. This arrangement enables the cutting edges and the rounded cutting edge to alternately pass over the same part of the workpiece surface as the tool is rotated while in contact with the workpiece, thereby providing a particularly effective way of simultaneously cutting and polishing curved, irregular and complex regions of workpieces. The use of cutting elements with rounded cutting edges as defined above is particularly advantageous in these embodiments.

A second aspect of the invention provides a method of polishing a workpiece, the method comprising:
providing a shaping tool in accordance with the first aspect at a surface of the workpiece;
moving the rigid shaping part against the surface of the workpiece so as to remove material from at least a part of the workpiece; and
biasing the polishing surface towards the first position while in contact with the part of the workpiece from which material was removed by the rigid shaping part, while moving the polishing surface against that part of the workpiece, thereby polishing that part of the workpiece.

This method achieves the advantages described above with reference to the first aspect and therefore provides a method by which a component can be manufactured from a workpiece in a fast, less complex manner than has previously been possible.

A method of polishing a workpiece, the method comprising:
moving a rigid shaping part against a surface of the workpiece while in contact with the workpiece so as to remove material from the workpiece, thereby forming at least one shaped region of the workpiece; and simultaneously:
applying a polishing surface of a deformable polishing part to one or more of the at least one shaped regions of the workpiece so as to polish said regions of the workpiece.

While the advantages of the invention are most strongly felt where the polishing surface and the rigid shaping part are integrated in a single tool, it is recognised that the same advantages may be achieved to some extent by simultaneously applying a rigid shaping part and a polishing surface to a workpiece even when the rigid shaping part and polishing surface are not part of the same integral tool. In this aspect, preferably, moving of the rigid shaping part and applying the polishing surface simultaneously is provided by applying the method of the second aspect.

### BRIEF DESCRIPTION OF THE DRAWINGS

FIGS. 1A and 1B show a first example of a shaping tool in accordance with an embodiment of the invention;

FIG. 2 shows the shaping tool of FIGS. 1A and 1B in use in a method in accordance with an embodiment of the invention;

FIG. 3 shows a second example of a shaping tool in accordance with an embodiment of the invention;

FIG. 4 shows a third example of a shaping tool in accordance with an embodiment of the invention;

FIG. 5 shows a fourth example of a shaping tool in accordance with an embodiment of the invention;

FIG. 6 is a close-up view of part of the polishing surface of the shaping tool of FIG. 5;

FIG. 7 shows the shaping tool of FIG. 5 arranged in an experimental setup;

FIG. 8 shows examples of tool paths used employed in an experiment using the setup of FIG. 7;

FIG. 9 shows the results obtained in experiments using the tool of FIG. 5 and other tools in accordance with comparative examples;

FIG. 10 shows measurements of material removal rate as a function of (a) feed rate, (b) grit size, (c) compression offset; and (d) measurements of form error for different tools;

FIG. 11 shows (a) form error and (b) roughness Ra measurement for conventional grinding tools and shaping tools in accordance with embodiments of the invention;

FIG. 12 shows the (a) surface texture and (b) transparency of a glass workpiece treated with a conventional grinding tool and the tool of FIG. 5;

FIG. 13 shows a further example of a shaping tool in accordance with an embodiment of the invention;

FIG. 14 shows a further example of a shaping tool in accordance with an embodiment of the invention;

FIG. 15 shows an example of a shaping tool configured for milling operations in accordance with an embodiment of the invention;

FIG. 16 shows another example of a shaping tool configured for milling operations in accordance with an embodiment of the invention;

FIG. 17 shows the shaping tool of FIG. 15 arranged in an experimental setup;

FIG. 18 shows profiles for conventional milling and hybrid mill-SAG performed using the tool of FIG. 15 for (a) aluminium and (b) steel;

FIG. 19 shows surface micrographs at various process conditions;

FIG. 20 shows measurements of surface roughness Ra variation with feed rate for (a) aluminium and (b) steel;

FIG. 21 shows measurements of frequency response function (FRF) of the FIG. 15 tool at offsets (a) P₀=0 mm, and (b) P₀=1.5 mm;

FIG. 22 shows measurements of viscous damping coefficient and stiffness variation with SAG offset;

FIG. 23 shows average forces for cutting force coefficient identification at (a) offset 0 mm, (b) offset 1.0 mm;

FIG. 24 is a stability lobes diagram for a conventional tool and the FIG. 15 hybrid tool for various compression offset (P₀) conditions;

FIG. 25 shows FFT analysis of the cutting forces for conventional milling and hybrid tools (offset=1.5 mm) tools at N=5735 rpm, a=0.4 mm.

### DETAILED DESCRIPTION

In this section, we will first describe examples of tools in accordance with embodiments of the invention. Then, we will describe in detail an experiment conducted using a tool in accordance with an embodiment of the invention and the results of this experiment.

### 1. Tool Examples

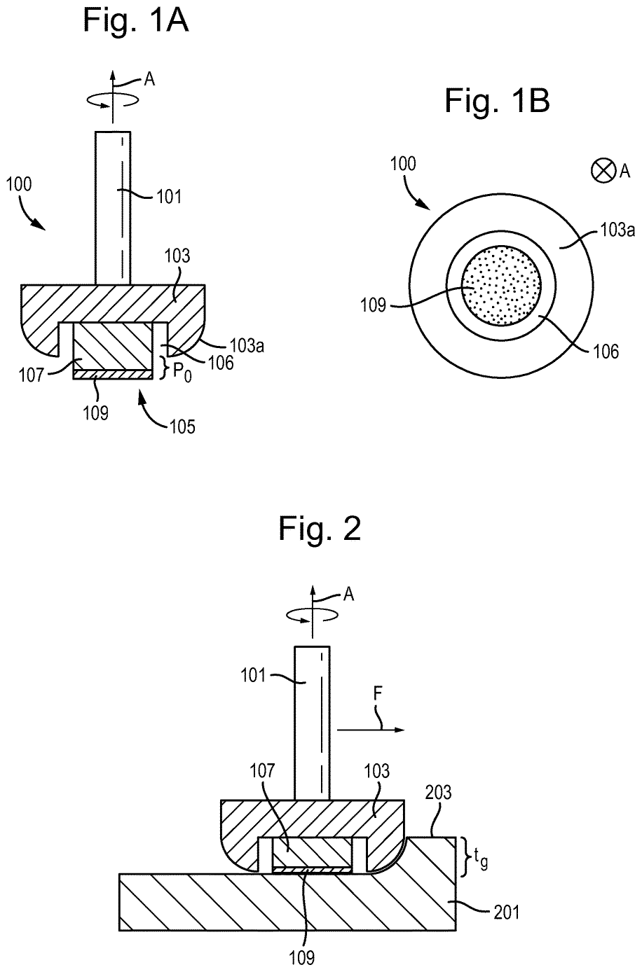

FIG. 1 is a cross-sectional view of a first example of a shaping tool 100 in accordance with an embodiment of the invention. The tool comprises a spindle 101 to which is affixed a rigid shaping part 103. In use, the tool 100 is rotated about a rotational axis A parallel to the spindle 101. An outwardly facing surface 103a of the rigid shaping part is applied to a workpiece (e.g. a glass blank to be shaped into a lens) while the tool is rotated about the axis A such that the outwardly facing surface removes material from the workpiece by movement against the surface of the workpiece. The rigid shaping part 103 can thus be moved along a predetermined tool path to impart, by removal of material, a desired shape to the workpiece.

The shaping tool 100 comprises a deformable polishing part 105. The deformable polishing part 105 comprises an elastic part 107, which is mounted in a recess 106 of the rigid shaping part 103. The elastic part carries a polishing surface 109, which in this case is a sheet of material that carries abrasive particles. The polishing surface 109 is configured to polishing the surface of a workpiece when moved against it.

When the deformable polishing part 105 is subject to no deforming forces, the polishing surface 109 occupies a first position (shown in FIG. 1A) in which it protrudes by a distance P₀ from the adjacent part of the outwardly facing surface 103a of the rigid shaping part 103. The distance P₀ may be referred to as the “compression offset” of the tool 100 and is determined by the shape of the elastic part 107 in its undeformed state.

FIG. 1B shows the shaping tool 100 when viewed from beneath along the axis A. The outwardly facing surface 103a has an annular form, such that the recess 106 is also annular. The deformable shaping part is cylindrical and is arranged in the recess 106 concentrically with the annular surface 103a about the rotational axis A. In this example, the rigid shaping part 103 and deformable polishing part 105 are rotationally symmetric about the axis A.

An example of a method of using the shaping tool 100 will now be described with reference to FIG. 2. This drawing shows the shaping tool 100 being used to shape and polish a workpiece 201. The tool is rotated about the rotational axis A an applied to the workpiece 201, which is held in position while being treated with the tool 100. The shaping tool 100 and workpiece 201 could be mounted in a shaping machine such as that shown in FIGS. 1-4 of WO2016/051121A1 for performing this operation. In such an arrangement, the tool 100 will be mounted in the shaping machine by the spindle 101. While rotating, the shaping tool 100 is applied to a surface 203 of the workpiece and translated in the direction F along a predetermined tool path parallel to the workpiece surface 203 and perpendicular to the rotational axis A. The rigid shaping part 103 contacts the workpiece surface 203 and removes material from it (by movement against the workpiece 201 due to the rotation of the tool 100 while in contact with the stationary workpiece 201). The tool path is configured such that a layer of material with a thickness t_{g} is removed from the workpiece surface 203 by the rigid shaping part 103.

As the tool 100 moves along the path, the deformable polishing part 105 is compressed along the direction of the axis A. The polishing surface 109 is biased, by the elastic part 107, towards first position, as a consequence of which it is urged against the shaped part of the workpiece 201. As the polishing surface 109 rotates about the axis A, it polishes that part of the workpiece. Therefore, as the tool 100 is moved along the tool path, the workpiece is, at least point along the tool path, first shaped by the rigid shaping part 103 and then polished by the polishing surface 109.

While the majority of the material removed from the workpiece 201 is due to the action of the rigid shaping part 103, the polishing of the workpiece 201 by the polishing surface 109 also removes a (relatively small) quantity of material from workpiece 201. As material is polished away, the polishing surface 109 begins to protrude relative to the adjacent part of the outwardly facing surface 103a of the shaping part 103, so the polished part of the workpiece 201 does not experience further grinding as the trailing end of the rigid shaping part 103 passes over it.

A cutting fluid such as water may be supplied to the point of contact between the workpiece and the tool 100 while the workpiece is being treated with the tool. Such a fluid can cool and lubricate the shaping and polishing parts.

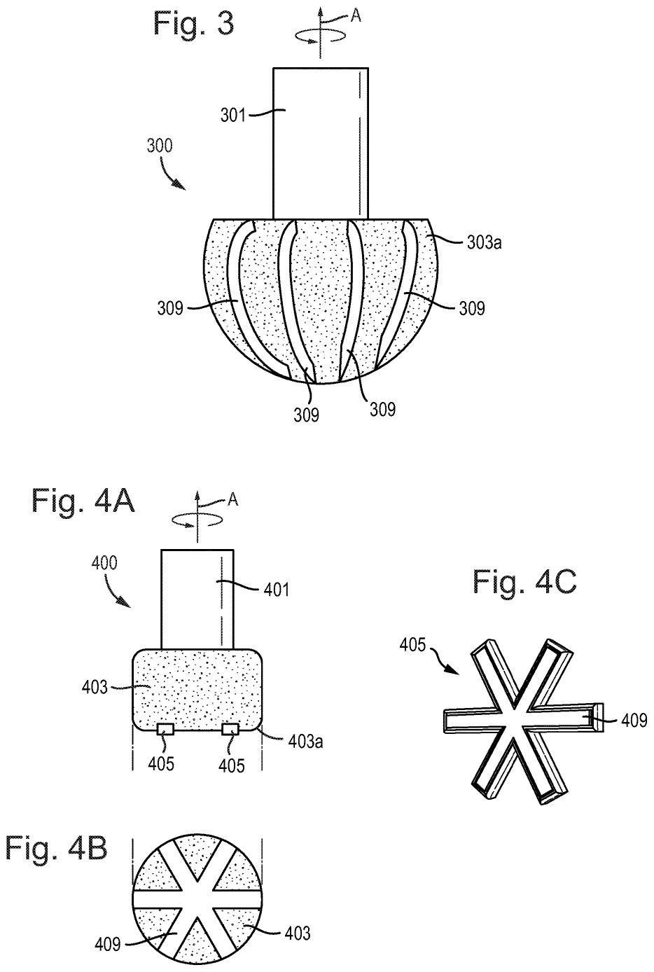

FIG. 3 shows a second example of a shaping tool 300 in accordance with an embodiment of the invention. The tool 300 here has a spindle 301 to which is affixed a rigid shaping part 303, which has curved outwardly facing surface 303a. The general form of the outwardly facing surface 303a is that of a section of a sphere. Like in the previous example, this tool 300 will be rotated in use about an axis aligned with the spindle 301 and the outwardly facing surface 303a of the rigid shaping part applied to the workpiece being treated so as to shape the workpiece.

In this example, the rigid shaping part 303 has a plurality of grooves extending along its surface and converging at the point opposite the spindle 301 (through which the rotational axis of the tool passes). In the grooves is disposed a deformable polishing part which comprises a polishing surface 309. Similarly to the shaping tool 100 of FIG. 1A, the polishing surface 309 in this example is biased towards a first position in which it protrudes relative to the adjacent region of the outwardly facing surface 303a by an elastic part positioned in the grooves.

The polishing surface 309 will occupy the first position when the deformable polishing part is not subject to any deforming forces. Each part of the deformable polishing part may be compressed (e.g. by urging the tool against a workpiece) such that the polishing surface 309 lies in a second position level with the adjacent region of the outwardly facing surface 303a (in which it is biased towards the first position by the compressed elastic part). Therefore, as the tool 300 is rotated about the axis aligned with the spindle 301 and applied to a workpiece, material is removed by the rigid shaping part and, because the polishing surface 309 is biased towards the protruding first position, polished by movement of the polishing surface 309 against the shaped parts of the workpiece.

This ‘spherical’ tool 300 is particularly useful for treating workpieces with complex shapes and difficult-to-reach parts such as prosthetics.

A third example of a shaping tool 400 in accordance with an embodiment of the invention is shown in FIGS. 4A-4C. Again the tool includes a spindle 401 to which is affixed a rigid shaping part 403 having an outwardly facing surface 403a suitable for shaping a workpiece in use. The rigid shaping part 403 has a generally cylindrical form, similar to the corresponding part in the FIG. 1A. However, the rigid shaping part 403 here has a plurality of grooves that extend across the surface opposite the spindle and intersect one another at the point where the axis of the spindle A intersects the outwardly facing surface 403a. The deformable polishing part 405 biases the polishing surface 409 towards a first position, shown in FIG. 4A, in which the polishing surface 409 protrudes relative to the adjacent region of the outwardly facing surface but can be deformed such that the polishing surface 409 lies level with the same region of the outwardly facing surface 403a.

The shaping tools of FIGS. 3 and 4A-4C are particularly advantageous as, when they are applied to a workpiece, the entire area shaped by the rigid shaping part 303, 403 will also be polished by the polishing surface 309, 409. This is because the arrangement of the polishing surfaces 309, 409 is such that the rotation of the tool alternately brings the shaping part 309, 409 and the polishing surface 309, 409 across the part of the workpiece to which the tool 300, 400 is applied. By contrast, the concentric design shown in FIG. 1A requires the tool 100 to be translated in order for the polishing surface 109 to reach the part of the workpiece shaped by the rigid shaping part 103 (as can be seen in FIG. 2).

### 2. Experiment

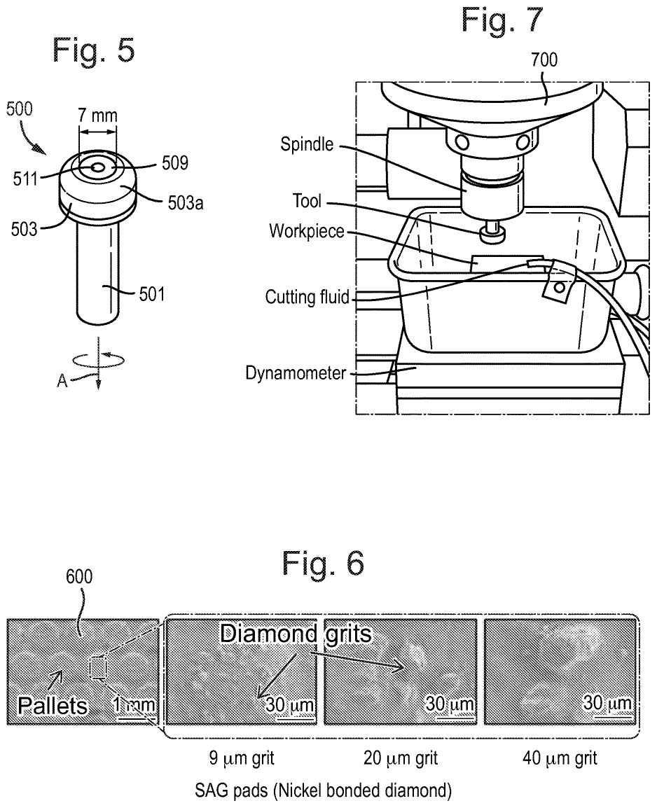

FIG. 5 shows a shaping tool 500 in accordance with an embodiment of the invention. The design of this tool is similar to that of FIG. 1A, in that the tool 500 comprises a spindle 501 affixed to a rigid shaping part 503 and a polishing 509 surface arranged on an elastic part mounted in a central recess of the rigid shaping part 503. However, the polishing surface here has a central aperture 511 such that the rotational axis A of the tool 500 does not pass through the polishing surface 509, which has an annular form. This is beneficial because, when the polishing tool of FIG. 1A is rotated about its rotational axis A, the velocity of the polishing surface radially near the axis A is very low. This means that the central part of the polishing surface 109 does not provide significant polishing, but still contributes significantly to heating and wear of the polishing surface. Furthermore, where a cutting fluid such as water is supplied to the polishing surface in use, the fluid cannot easily reach the central part of the polishing surface, which exacerbates these problems. Providing the central aperture 511 in the polishing surface 509 overcomes these drawbacks because now the entire polishing surface 509 will be fast-moving against the workpiece surface and, if provided, have good supply of cutting fluid.

FIG. 6 shows SEM micrographs of part of the polishing surface 509. The polishing surface carries abrasive pellets 600 in which are contained diamond grits (shown in close-up at different scales in the three right-hand frames).

The shaping tool 500 of FIG. 5 was used to perform an experiment using the apparatus shown in FIG. 7. The tool 500 was mounted by the spindle in a shaping machine 700 configured to rotate to tool 500 about its axis A and bring it into contact with a workpiece. The workpiece was clamped in place in a bath of cutting fluid (water) and the tool was translated. The conditions and results of this experiment will now be described in detail.

### 2.1 Tool Preparation

Three types of tools were considered in this experiment: (1) stiff grinding tools, (2) SAG tools, and (3) hybrid tools, as shown in FIG. 5. A commercially available cup grinding tool of diameter ($) 12 mm was procured (Dr. Müller DIAMANT METALL AG, Germany). This grinding tool can produce a surface roughness Ra<0.5 μm on ceramic and glass surfaces. The SAG tool was prepared in-house using a steel shank of φ8 mm. Natural rubber of 3 mm thickness and shore hardness 64A was stuck on the shank using contact glue. A pad of nickel bonded diamond (NBD) pellets was then fixed onto the rubber surface. The hybrid tool was prepared by combining a commercial grinding tool and the SAG tool together, whereby the soft rubber and NBD pad assembly were inserted within the pocket on the cup grinding tool. From the preliminary experiments, it was observed that the SAG pad could wear out and detach rather quickly. This is believed to be due to cutting fluid supply deficiency across the SAG pad surface, as the pad is fully surrounded by the grinding head and cutting velocity near the centre is almost negligible, resulting in high rubbing and friction (Pratap, A., Patra, K., and Dyakonov, A. A., 2018, On-Machine Texturing of PCD Micro-Tools for Dry Micro-Slot Grinding of BK7 Glass, Precis. Eng., 55 (November 2018), pp. 491-502). Therefore, a φ2 mm hole was bored into the centre of SAG tool, which was confirmed to significantly reduce pad wear. Hybrid tools with different compression offsets (PO) were prepared by altering the depth of the pocket on the tool. SAG pads with different abrasive grit sizes (e.g. 9, 20, 40 μm) were used in the experiments, for which SEM micrographs are also shown in FIG. 6.

TABLE 1
Parameters of grinding tool type comparison.

| | | |
|---|---|---|
| (1) | Conventional | Depth of cut (tg): 20 μm |
| | grinding | Feed rate (f): 30 mm/min |
| | | Spindle rotation (n): 1500 rpm |
| | | Binder/abrasives: Nickel-bonded diamond |
| | | (#400) cup grinding tool |
| | | Tool diameter: 12 mm |
| (2) | Shape | Compression offset (PO): 0.35 mm |
| | adaptive | Feed rate (f): 30 mm/min |
| | grinding | Spindle rotation (n): 1500 rpm |
| | (SAG) | Binder/abrasives: Nickel-bonded diamond (9, |
| | | 20, 40 μm) |
| | | Tool diameter: 7 mm |
| (3) | Proposed | Depth of cut (tg): 20 μm |
| | hybrid tool | Compression offset (PO): 0.35 mm |
| | | Feed rate (f): 30 mm/min |
| | | Spindle rotation (n): 1500 rpm |
| | | Tool diameter: 12 mm |
| (4) | 2 step | (1) followed by (2) with same parameters |
| | grinding + | |
| | SAG | |

TABLE 2
Parameters for evaluation of hybrid tool grinding characteristics.

| Workpiece | BK7 glass |
|---|---|
| Feed rate f | 30, 60, 90 |
| (mm/min) | |
| Compression | 0.15, 0.25, 0.35 |
| offset PO | |
| (mm) | |
| Abrasive grit | 9, 20, 40 |
| size of the pad | |
| (um) | |

### 2.2 Experimental Plan

Experiments were carried out on a 3-axis CNC machining platform (NVX5000, DMG Mori Ltd.). A cutting fluid containment unit was attached on top of a dynamometer (Kistler, 257B), which in turn was mounted on the machine table as shown in FIG. 7. A workpiece, which was a highly polished BK7 glass window with initial surface roughness Ra~3 nanometres (nm), was clamped within the containment unit. This method, in which a highly polished mirror surface is degraded by the grinding process, is commonly used to determine the potential removal and roughness achievable with the target process. The cutting fluid (water) was supplied to the workpiece surface using a peristaltic pump. The tool was clamped in the spindle using a collet chuck, and path length of 35 mm was kept constant for each tool, in order to nullify any surface texture dependency on vibration or chatter caused by different path lengths. Two sets of experiments were planned. The first set of experiments compares the performance of proposed hybrid tool with conventional grinding and SAG tools. Four experiments were set up in this stage. Three experiments were performed with each type of tool and its associated parameters as described in table 1. Additionally, a fourth experiment was planned with the conventional grinding and SAG tools used in sequence (noted ‘grind-SAG’ hereafter) on the same surface, in order to confirm if the proposed hybrid tool can achieve similar performance to the separate tools in sequence.

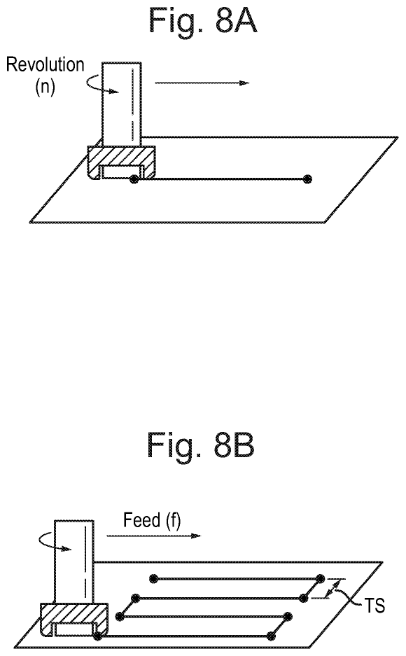

The second set of experiments establishes the removal and surface finish capability of the hybrid tool in relation to the process parameters, viz. feed rate (f), compression offset (PO), and abrasive grit size, as shown in Table 2. Two types of tool paths were adopted as described in FIG. 8. To observe the removal rate of the processes, a single-track tool path was considered where the tool traverses on the work surface only one time as shown in FIG. 8(a). Next, a raster tool path with track spacing (TS) of 0.2 mm was generated over a 20 mm×20 mm square surface, as described in FIG. 8(b), inside which the roughness and form error were measured to establish the tool performance for precision grinding.

### 2.3 Results and Discussion

### 2.3.1 Comparative Material Removal and Finishing Performance

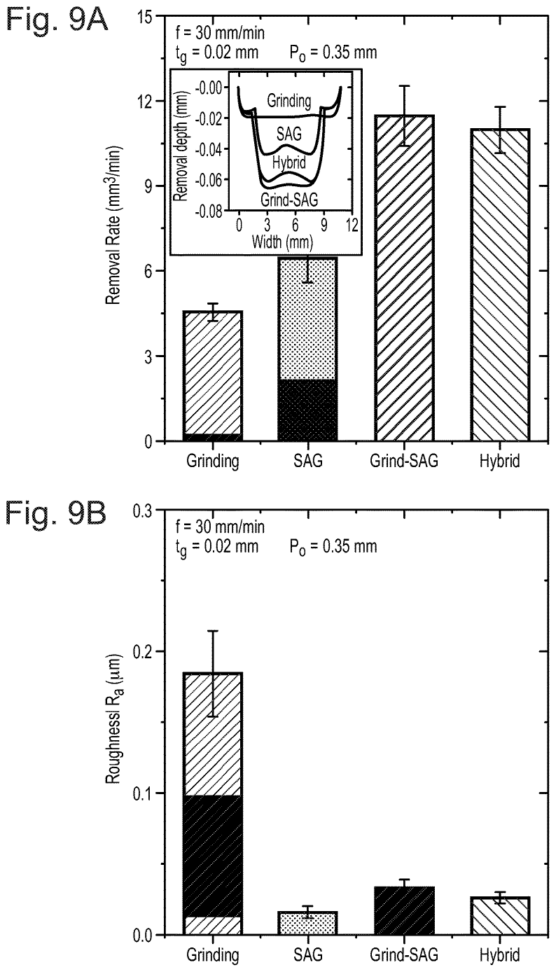

The material removal profiles of the various tools were measured using a contact profilometer with 2 μm radius diamond tip (Taylor-Hobson, Form Talysurf PGI1240). The data was analysed to obtain the removal rate (mm3/min) and average roughness Ra (μm), as shown in FIG. 9. Conventional grinding removed the least amount of material, and material removal steadily increased in the case of SAG, grind-SAG and hybrid process. Large amount of removal from SAG resulted from the low feed-rate of 30 mm/min, as removal depth in SAG is inversely proportional to the feed-rate. Removal rate with the hybrid tool was almost comparable to using the two discrete tools in sequence, which establishes that the hybrid tool can be used to save processing time. Average roughness Ra measured inside the raster areas was 0.18 μm for conventional grinding and 0.016 μm for the SAG process. Roughness achieved with the hybrid tool (Ra=0.025 μm) and grind-SAG (Ra=0.031 μm) was comparable, though the processing time with the hybrid tool of the invention is only half that of grind-SAG.

### 2.3.2 Grinding Characteristics as Function of Controlling Parameters

In the experiment described above, material removal from the SAG pad was found to be very high and the removal profile was observed to distort in the central region of removal (see inset in FIG. 8(a)). The target for optical surface generation is to achieve the lowest possible removal from SAG pad while using the hybrid tool of the invention, just enough to remove the cracks and damage layer from the ground surface. The influence of controlling parameters was therefore studied in order to achieve this target of shallow removal, controlled surface form, and good surface finish.

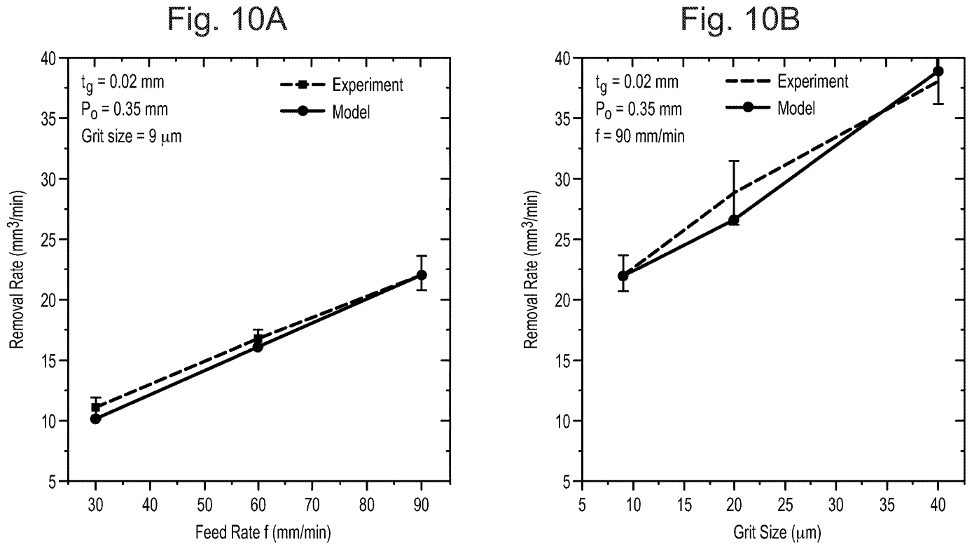

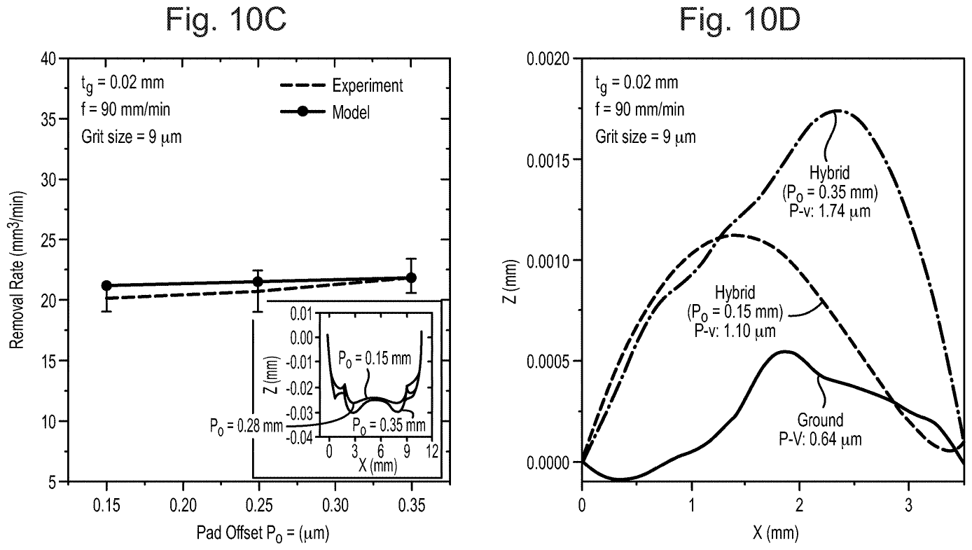

The experimental removal rate of hybrid tool in relation to feed rate f, abrasive grit size of the SAG pad, and compression offset P_{O} is plotted in FIG. 10. On increasing the feed-rate from 30 to 90 mm/min, the overall removal rate increased whereas the removal depth decreased due to a lesser contribution from the SAG pad. Therefore, high feed rate of 90 mm/min seemed suitable to achieve high removal rate with minor profile distortion. Removal rate also increased when pad grit size was varied from 9 to 40 μm, as shown in FIG. 10(b). Smaller grit size resulted in a shallower removal depth. The compression offset P_{O} had a relatively small effect on removal rate as compared to feed rate and grit size, as shown in FIG. 10(c). A low offset value of 0.15 mm was found to be favourable for generating an undistorted and flat removal profile, as shown in the inset of FIG. 10(c). Material removal depth is higher towards the edge of the SAG contact zone, but this variation can be reduced with a decrease in the compression offset. The form error in terms of P-V (peak-to-valley) height of the raster generated surfaces at two different compression offsets (P_{O}=0.15 and 0.35 mm) were compared with a conventionally ground surface, as shown in FIG. 10(d). P-V was 1.10 μm for the hybrid tool at P_{O}=0.15 mm, as compared to P-V=0.64 μm for the conventionally ground surface. The form error increased to ~1.74 μm for PO=0.35 mm. Therefore, large feed rate, small grit size, and low compression offset value are suitable to maximize material removal rate while and preserving the flatness of ground profile.

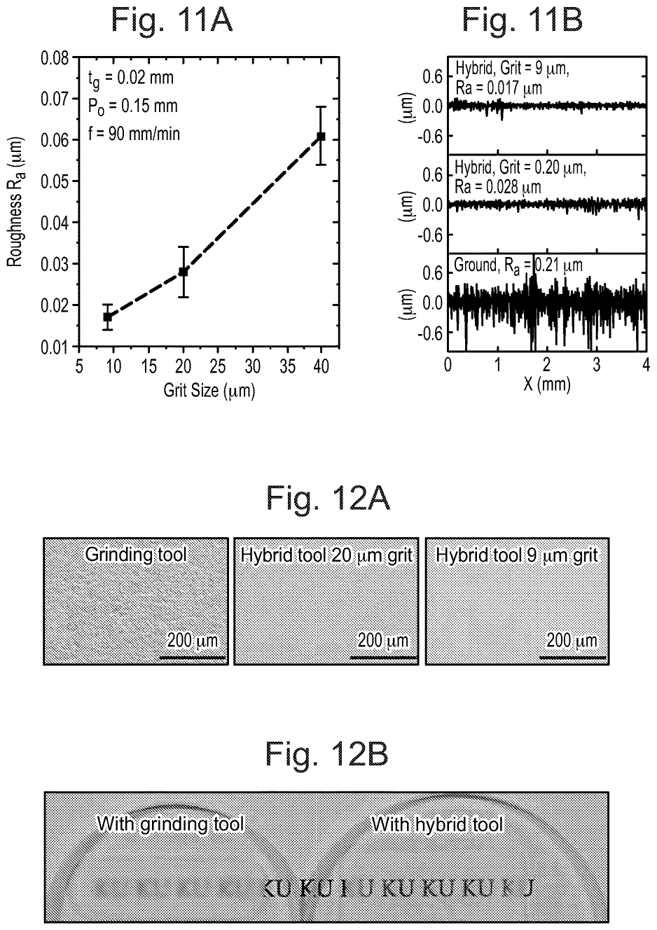

Surface roughness, texture and transparency were observed. The average roughness Ra increased from 0.017 μm to 0.061 μm as the grit size increased from 9 to 40 μm, as shown in FIG. 11(a). Roughness profiles of surfaces rastered with the conventional tool and hybrid tool are plotted in FIG. 11(b). Surface topography was captured with a scanning electron microscope (Hitachi High-Tech Corp. FE-SEM SU-8020), as shown in FIG. 12(a). Significant brittle fractures and pits could be observed on the conventionally ground surface. The surface processed with 20 μm grit hybrid tool showed very fine pitted tracks on the surface that indicate mixed ductile-brittle mode. The surface processed with 9 μm grit hybrid tool was almost free from cracks and fractures, and thus almost qualifies as ductile mode. Relative transparency of the surfaces is compared in FIG. 12(b). The surface generated with the hybrid tool was glossy while the conventionally ground surface had a frosted finish, even though both surfaces were obtained within the same process time.

In the example just described, a method for shortening process time when generating optical surfaces has been introduced. The hybrid tool in accordance with the invention enabled precision finishing of flat surfaces in a single run, eliminating the need for sequential grinding, fine grinding and polishing operations. The performance of the developed hybrid tool was established in relation to process parameters such as feed rate, compression offset, and grit size. High feed rate together with small grit size and low compression offset could produce smooth and flat surfaces, with an average roughness of 0.017 μm Ra, compared to 0.21 μm Ra for a conventionally ground surface with the same processing time.

The proposed hybrid tool design is easy to use and sets a basis to develop other integrated tools combining SAG with milling or turning processes. The potential of such tools to achieve single step finish processing on a large range of materials seems promising.

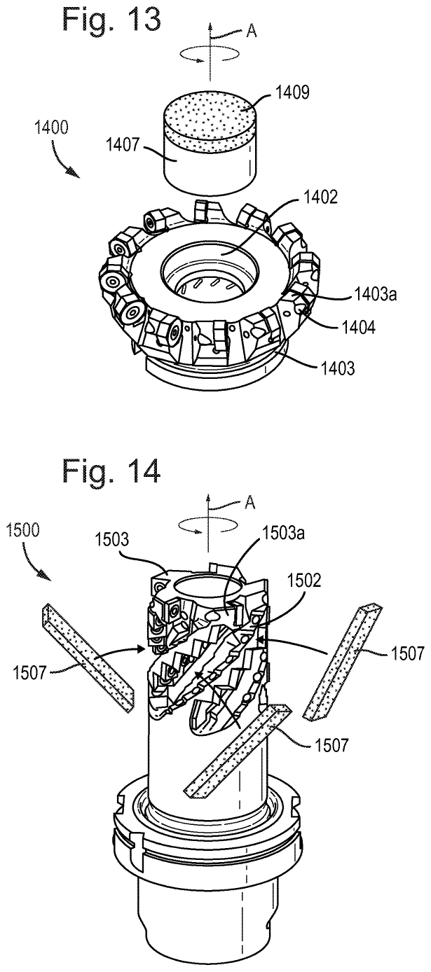

FIG. 13 shows a further example of a shaping tool 1400 in accordance with an embodiment of the invention. The tool is shown in a deconstructed state. In this embodiment, the shaping tool 1400 is adapted for milling operations. The tool includes a rigid shaping part 1403, which is generally rotationally symmetric about a rotational axis A of the tool. A plurality of teeth 1404 are arranged around the circumference of the rigid shaping part 1403 and the upper surfaces of the teeth 1404 along the direction A form an outwardly facing surface 1403a which, in use, are capable of shaping a workpiece when brought into contact with the workpiece while the tool 1400 is rotated about the axis A. Tools with this configuration may be described as “face milling cutters”, since the tool is brought into contact with the workpiece along the direction of the rotational axis A.

The rigid shaping part is shaped to define a recess 1402 in which, when assembled, a deformable polishing part 1407 comprising a polishing surface 1409 is disposed. The recess 1402 and the deformable polishing part 1407 are proportioned such that in the assembled tool, the polishing surface 1409 will protrude along the direction of the rotational axis A relative to the outwardly facing surface 1403a formed by the upper parts of the teeth 1404. The shaping tool 1400 of this embodiment will therefore treat the workpiece similarly to that of FIGS. 1A-2, in the sense that the centrally-arranged polishing surface will polish parts of the workpiece from which material was removed by the teeth 1404 as the tool is translated laterally, while in contact with the workpiece, in the manner shown in FIG. 2.

FIG. 14 shows a further example of a shaping tool 1500 in accordance with an embodiment of the invention, which is, like the previous example, configured for milling operations. The shaping tool 1500 is shown in a deconstructed state. The configuration of this tool 1500 differs from that of FIG. 13 in that this tool 1500 is an example of a “side milling cutter” in which the part of the tool configured to contact the workpiece in use is formed by the sides of the tool (which lie parallel to the rotational axis A of the tool) rather than the part facing along the direction of the rotational axis A.

The tool 1500 has a rigid shaping part 1503 with a generally cylindrical form. A plurality of helical grooves 1502 are formed in the rigid shaping part 1503, and the parts of the curved surface between the grooves form an outwardly facing surface 1503a that will contact the workpiece in use and remove material from the workpiece as the tool rotates about the axis A.

The tool comprises a plurality of deformable polishing parts 1507, each of which is formed by a strip of deformable (e.g. elastic) material. Each deformable polishing part carries a polishing surface 1509. In the assembled tool, the deformable polishing parts 1507 are each placed into a respective one of the helical grooves 1502 such that the polishing surface 1509 protrudes from the helical groove 1502 relative to the outwardly facing surface 1503a formed by the parts of the tool between the grooves. As the tool 1500 is rotated about the axis A and brought into contact with a workpiece, each part of the workpiece in contact with the tool 1500 will alternately be subject to the sections of the outwardly facing surface 1503 between the grooves 1502 and the polishing surfaces 1509 protruding from the grooves 1502.

### 3. Further Milling Tool Examples

Further examples of tools in accordance with an embodiments of the invention will now be described. The tools in these embodiments are configured for performing milling operations and provide particular advantages in the context of milling, which will be described below. Then, experiments carried out with a tool constructed in accordance with these embodiments will be described.

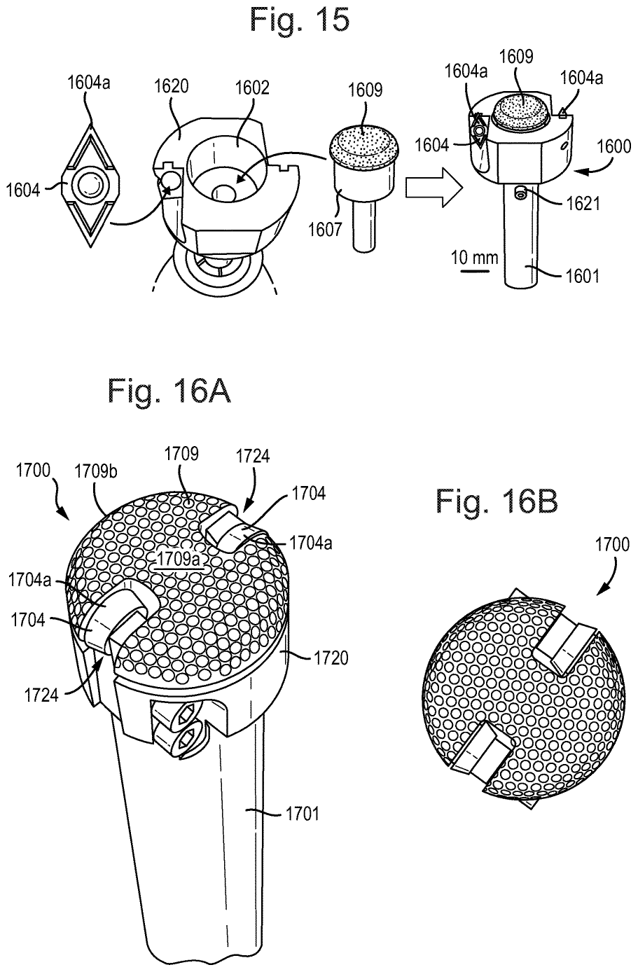

FIG. 15 shows an example of a shaping tool 1600 in accordance with an embodiment of the invention. This tool is an example of an embodiment in which the rigid shaping part comprises one or more cutting elements each comprising a respective cutting edge arranged to remove material from the workpiece when placed in contact with the surface of the workpiece and moved against the surface of the workpiece, the outwardly facing surface comprising the cutting edges of the one or more cutting elements.

This tool 1600 is configured to perform milling operations. The tool comprises a spindle 1601 to which there is fixed a tool body part 1620, held in plane by a grub screw 1621. Mounted on the tool body part 1620 are two cutting elements 1604, which in this case are diamond-shaped milling inserts, which have cutting edges 1604a. When the tool is rotated about the rotational axis aligned with the spindle 1601 and the cutting edges are brought into contact with a workpiece to be shaped, the cutting edges 1604a move against the surface of the workpiece and thereby remove material from the workpiece. In this embodiment, the rigid shaping part is provided by the cutting elements 1604 and the cutting edges 1604a define the outwardly-facing surface of this part.

The tool body part 1620 comprises a recess 1602, in which a deformable polishing part is situated. The deformable polishing part comprises a compressible rubber part 1607 and a polishing surface 1609, which is a pad carrying abrasive particles on its outer surface (and is therefore capable of performing shape adaptive grinding).

The compressible rubber part 1607 and the polishing surface 1609 are arranged so that the polishing surface 1609 protrudes, relative to the cutting edges 1604a, away from the tool body 1620 when undeformed, and when placed in contact with a workpiece may be compressed such that the polishing surface 1609 lies level with the cutting edges 1604a. Thus, when the tool is rotated about the axis aligned with the spindle 1601 and the cutting edges 1604a are brought into contact with a workpiece, the cutting edges 1604a remove material from the workpiece and the rotating polishing surface 1609 polishes the part of the workpiece with which it is in contact. The tool 1600 may be moved laterally relative to the workpiece surface, while rotating, such that the polishing surface comes into contact with the parts of the workpiece surface from which cutting edges 1604a have removed material.

In the FIG. 15 tool, the milling inserts 1604 are indexable milling inserts (Make: Kyocera, Model: PV720) have an edge radius of 0.1 mm, and are located 13 mm from the tool axis. The SAG tool part (i.e. the polishing surface 1609) is cut from an existing standard 15 mm diameter cap type SAG tool (Make: Zeeko, Model: C15).

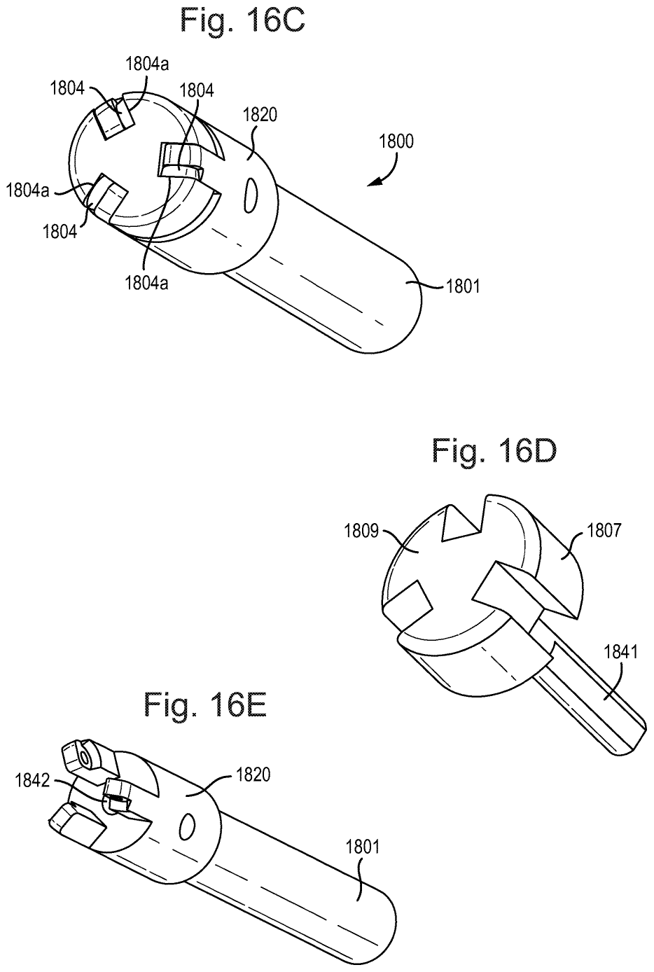

A further example of a shaping tool 1700 configured for milling operations is shown in FIG. 16, which shows (a) a perspective view of the tool 1700 and (b) a plan view of the tool 1700, looking towards the end of the tool. Like the tool of FIG. 16, this tool 1700 comprises a spindle 1701 on which is mounted a tool body part 1720. The tool 1700 also includes a deformable polishing part comprising a three-dimensional polishing surface 1709 and a deformable rubber part (not visible) below the polishing surface.

In this example, the polishing surface 1709 is a three-dimensional surface (i.e. it is not a flat plane) and comprises a flat, central region 1709a and a rounded edge region 1709b, which extends circumferentially around the central region 1709a. The rounded edge region 1709b is shaped to define two recessed areas 1724 on opposite sides of the polishing surface 1709, in each of which is situated a rounded cutting element 1704. The rounded cutting elements in this case are milling inserts removable mounted on the tool body part 1720. The cutting elements 1704 have cutting edges 1704a, which are capable of removing material from a workpiece when the tool is rotated about the axis aligned with the spindle 1701 and brought into contact with the workpiece.

The polishing surface 1609 is arranged such that, when the deformable polishing part is undeformed, the polishing surface 1609 protrudes away from the tool body 1720 relative to the cutting edges 1704a. When the cutting edges are placed in contact with a workpiece, the polishing part may be compressed such that the parts of the polishing surface 1609 adjacent to the recessed areas 1724 are level with the respective cutting edges 1704a.

This tool 1700 is capable of shaping and polishing a workpiece while placed in contact with the workpiece at a range of different orientations thanks to the rounded edge region 1709b of the polishing surface 1709 and rounded cutting elements 1704. For example, flat regions of a workpiece could be shaped by bringing the flat central region 1709a into contact with the workpiece while the tool 1700 is rotated and moved laterally relative to the workpiece surface, whereas the rounded edge region 1709b is capable of shaping non-flat regions (e.g. concave or convex regions) of a workpiece. It will be appreciated that, when rounded edge region 1709b is placed in contact with the workpiece as the tool 1700 is rotated, no lateral translation of the tool 1700 is required in order for the parts shaped by the cutting edges 1704 to be polished by the polishing surface 1709 because the rotation of the tool alternately brings the cutting edges 1704 and the rounded edge region 1709b into contact with the same region of the workpiece surface. The shaping tool 1700 of FIG. 16 is therefore a particularly preferred embodiment of the invention since it is capable of shaping and polishing curved, irregular and complex workpieces.

As will be shown below by the experiment described in section 4, tools of the kind shown in FIGS. 15 and 16 achieve a significant reduction chatter (i.e. vibration or oscillation of the tool relative to the workpiece) during milling operations in addition to the advantages discussed above. This is believed to be at least in part due to a damping effect provided by the deformable polishing part. This reduction in chatter is particularly beneficial in the context of milling performed by industrial robots, which typically hold the tools in significantly less rigid configurations than conventional machines and are therefore particularly prone to suffering significant vibration or oscillation of the tool in use.

FIG. 16(c) shows a further example of a shaping tool 1800 in accordance with an embodiment, which is a variation of the tool 1700 shown in FIGS. 16(a) and (b). Like the FIG. 16(a) tool, the shaping tool 1800 of FIG. 16(c) comprises a spindle 1801 to which a tool body part 1820 is affixed. Removably mounted on the tool body part 1820 are three rounded cutting elements 1804 (which in this case are rounded milling inserts) which are equally spaced from one another in the circumferential direction around the axis of the tool along which the spindle 1801 is oriented. The tool has a polishing surface 1809 that is shaped with three recessed portions each arranged to accommodate a respective one of the cutting elements 1804.

The polishing surface 1809 is part of a polishing part shown in FIG. 16(d). The polishing part includes an elastic (e.g. rubber) part 1807 on which the polishing surface 1809 is carried. The elastic part 1807 is affixed to a shank 1841 which is shaped to be received by a corresponding bore 1842 in the tool body part, which is shown (together with the spindle 1801) in FIG. 16(e).

### 4. Milling Tool Experiment

An experiment that was performed using the tool shown in FIG. 15 will now be described.

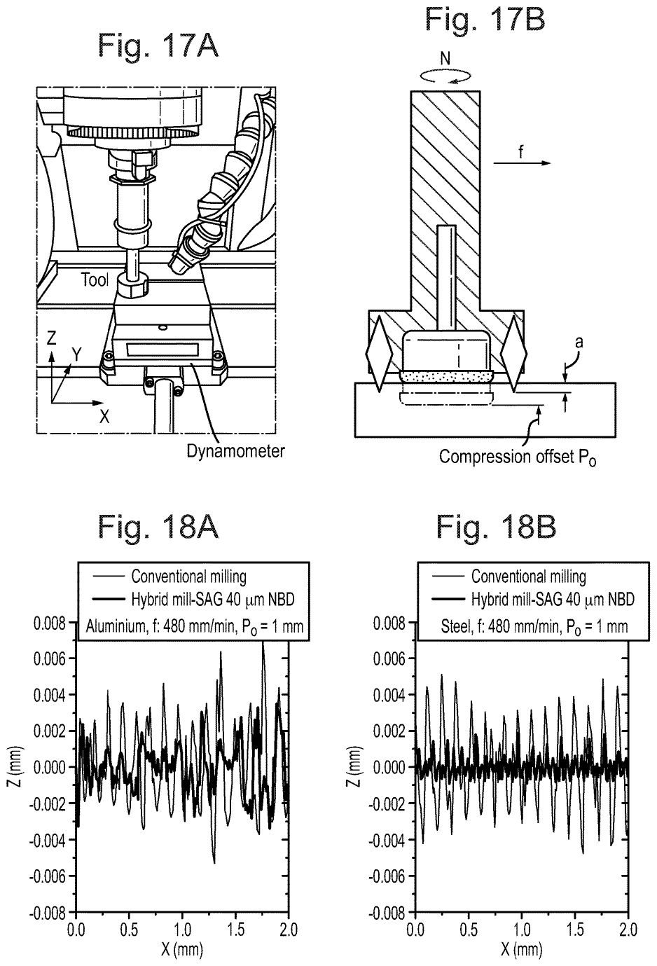

Experiments using the shaping tool 1600 of FIG. 15 were carried out on a 4-axis CNC machine (Make: Fanuc, Model: Robodrill α-D21MiA). The experimental setup is shown in FIG. 17(a). FIG. 17(b) shows the tool-workpiece contact condition of the hybrid tool. The process carried out with the hybrid tool is referred as hybrid mill-SAG hereafter. The SAG part of the tool is set at an offset P₀ from the cutting insert. When a cutting depth a is set relative to the milling inserts, the SAG core (i.e. the deformable polishing part, including the polishing surface 1609 and rubber part 1607) gets compressed against the workpiece, by virtue of the elastic nature of SAG core. The cutting inserts (i.e the milling inserts 1604) machine the workpiece material while the SAG core finishes the cut surface simultaneously.

Process parameters for conventional milling and hybrid mill-SAG are presented in Table 3. Both steel and aluminium workpieces were machined with the conventional milling and hybrid tools. Tool rotation speed was kept constant and the effect of feed rate on surface generation was established. 3 wt % Syntilo™ 9913 was used as the cutting fluid.

TABLE 3
Experimental parameters for milling and hybrid tool

| | |
|---|---|
| | Workpiece: Plates of steel SS400 and aluminium |
| | Cutting fluid: A5052 3 wt % Syntilo ™ 9913 |
| | Feed rate (f): 160-800 mm/min |
| | Spindle rotation (N): 4000 rpm |
| | Depth of cut (a): 0.2 mm |
| Conventional | Tool structure: Face milling tool with indexable |
| milling | inserts |
| | Tool diameter: 26 mm |
| | Corner radius: 0.1 mm |
| | Coating: PVD |
| Hybrid | Tool structure: Face milling tool with indexable |
| Mill-SAG | inserts + SAG core |
| | SAG pads: Nickel-bonded diamond (9, 40, 80 μm) |
| | Pad diameter: 15 mm |
| | Rubber hardness: 60A |
| | Compression offset (P_{O}): 1 mm |

### 4.1 Surface Generation by Milling Vs. Hybrid Tool

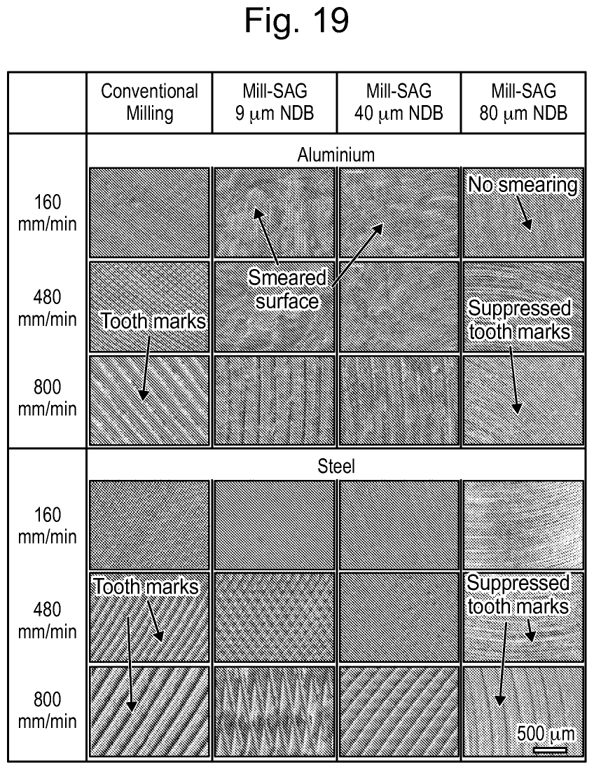

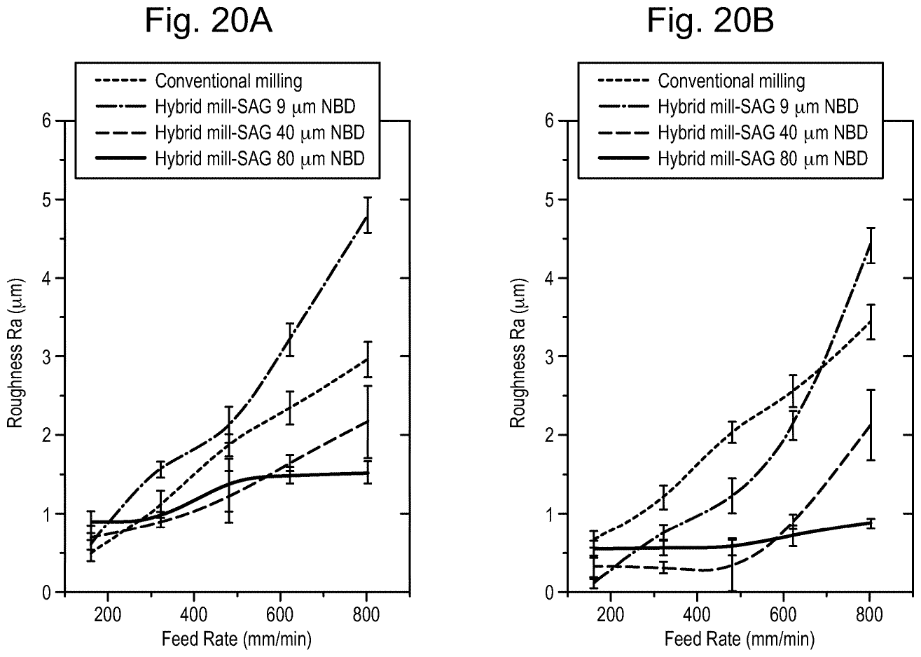

The primary goal is to observe the suppression of the large amplitude roughness generated by conventional milling tool when using the hybrid tool. Surface roughness was measured using a contact type profilometer (Make: Taylor Hobson, Model: PGI1240). Surface profiles for the processed aluminium and steel are shown in FIG. 18. It is evident from the profiles that the hybrid tool successfully suppresses the large roughness produced by the indexable cutting inserts. Micrographs of the surfaces generated with conventional milling and hybrid mill-SAG are shown in FIG. 19. Surface roughness variation with feed rate is shown in FIG. 20. The conventional milling tool generates arc-like marks on the surface. In the case of aluminium, the surface generated with hybrid mill-SAG seems a little worse at low feed rates. The aluminium surface looks smeared at low feed rates, due to the high rubbing and friction of SAG pad combined with the high ductility of the material. The phenomenon is more prevalent when using 9 μm or 40 μm NBD pads, as there are more grits per unit area on these pads, and so each abrasive grit receives a lower load to push it onto the workpiece surface. This causes lower penetration and more rubbing effect on soft workpiece material like aluminium. When using the hybrid tool with 80 μm NBD pad, there was no evidence of material smearing and surface roughness was very stable over the whole range of feed rate values, as shown in FIG. 20(a). In the case of steel, there is no evidence of material smearing with any of the SAG pads. The hybrid tools with 9 μm, 40 μm and 80 μm NBD were suitable to generate a lower surface finish as compared to that of conventional milling only tool. However, when the feed rate was 800 mm/min, the 9 μm NBD pad failed to improve the surface. This can be attributed to the very rough surface generated by milling inserts at such large feed rate. Hybrid tool with 80 μm NBD performed well at high feed rate for both aluminium and steel materials. Roughness obtained with the hybrid tool at 800 mm/min was comparable to that achieved with milling at 160-320 mm/min. This demonstrates a possible productivity enhancement of ~60-80%. From these results, it appears that hybrid tools have potential to do away with the need for sequential rough milling followed by finish milling or grinding.

### 4.2 Chatter Stability of the Hybrid Tool

A vibration model of a mechanical structure with two degrees-of-freedom (2-DOF) is modeled by a combination of mass (m), spring (k), and damping (c) elements, using a displacement vector {x, y}^{T} and a force vector {Fx, Fy}^{T}. Regarding the hybrid tool, however, the spring (k) and damping (c) elements of the frequency response function (FRF) will change because the SAG part is compliant with the workpiece. Therefore, a new dynamic characteristic model that takes into account the change in the dynamic characteristics of the tool due to presence of SAG is proposed.

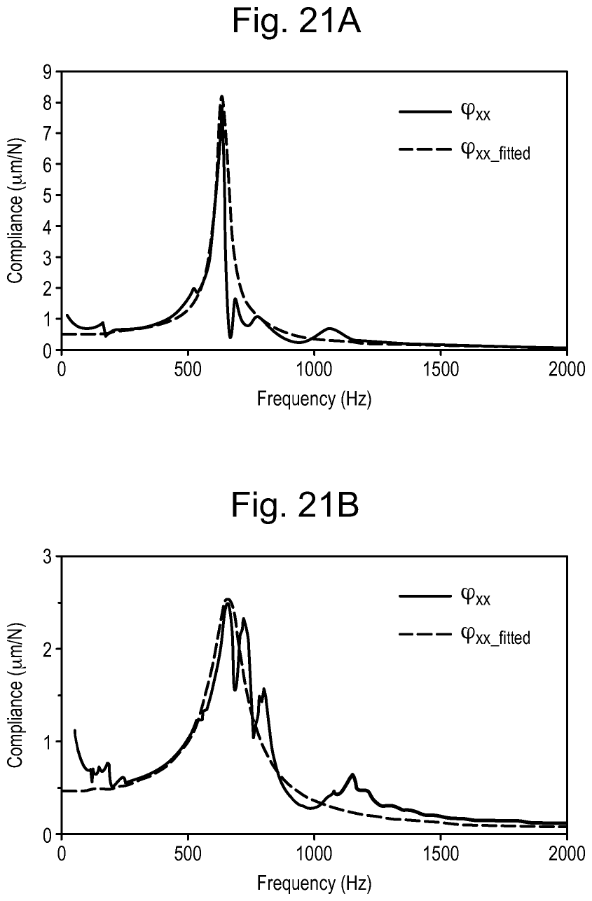

The FRFs of the structure were measured by hammer tap test. In the test, two accelerometers (Make: ONO SOKKI, Model: NP-3412) were attached to the tool in the x (feed) and y (normal) directions, and the tool was excited with an impact hammer (Make: Dytran Instruments Inc., Model: 5800B4) having a built-in force sensor. Then, from the input and output signals, the FRF of the mechanical structure was obtained, as shown in FIG. 21. The tests were conducted on the hybrid tool with each offset value in increments of 0.1 mm, from 0 mm to 1.5 mm. During these experiments, the SAG part of the tool was compressed against the machine table at different compression offsets. The obtained decibel value of the gain of the inertance was changed to the value of the gain of compliance. This data was used to analyze the modal parameters of the FRF of the tool. In this work, the single-degree-of-freedom (SDOF) method is used to estimate the parameters. The damping ratio ζ, stiffness k and damping c is calculated as described in literature (Nagamatsu A (1985) Modal Analysis, Baihukan). The results of the experimental modal analysis are shown in Table 4.

TABLE 4
Modal parameters for hybrid tool

| | | | | | Damping |
|---|---|---|---|---|---|
| SAG Offset | Natural | Damping | Stiffness k | Mass m | coefficient |
| (mm) | frequency | ratio ζ | [N/m] | [kg] | c [Ns/m] |
| 0 | 651.4 | 0.029 | 2.09 × 10⁶ | 0.125 | 29.32 |
| 0.5 | 665.3 | 0.050 | 2.19 × 10⁶ | 0.126 | 52.83 |
| 1.0 | 663.9 | 0.060 | 2.20 × 10⁶ | 0.126 | 63.17 |
| 1.5 | 669.9 | 0.087 | 2.24 × 10⁶ | 0.126 | 92.83 |

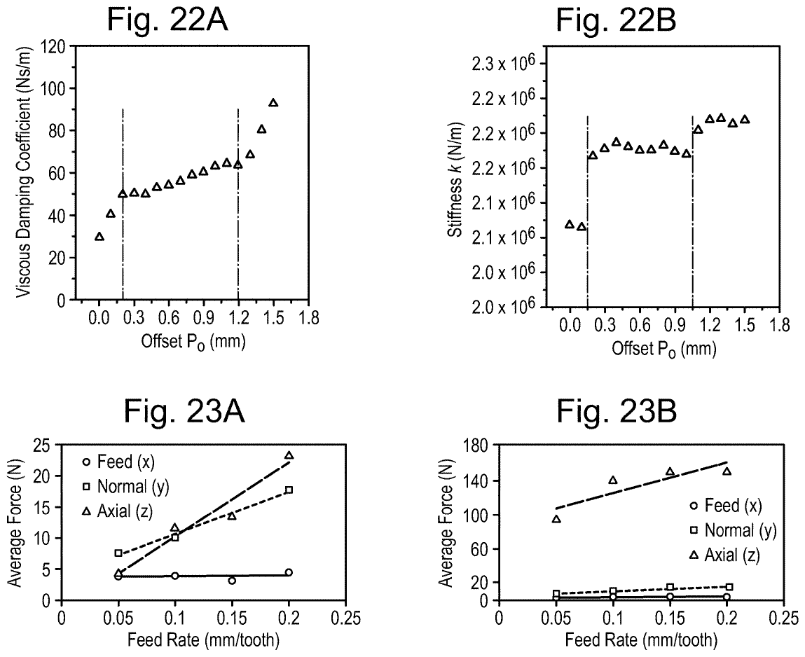

Variation of damping and stiffness with respect to the SAG offset is plotted in FIG. 22. It is evident that the increase in damping or stiffness is not linear over the offset range, rather it can be divided into three distinct regions. Based on the variation, a new dynamic model that takes into account the influence of SAG is considered to be as follows, where P₀ is the offset.

$${c}_{xx , new} = \{ \begin{matrix}{c}_{xx , 0} + {A}_{1} {P}_{0} ( 0 \leq {P}_{0} \leq 0.2 ) \\ {c}_{xx , 0.2} + {A}_{2} {P}_{0} ( 0.2 \leq {P}_{0} \leq 1.2 ) \\ {c}_{xx , 1.2} + {A}_{3} {P}_{0} ( 1.2 \leq {P}_{0} \leq 1.5 )\end{matrix} \qquad ( 1 )$$

$${k}_{xx , new} = \{ \begin{matrix}{\sum }_{i = 0}^{0.1} {k}_{xx , i} ( 0 \leq {P}_{0} \leq 0.2 ) \\ {\sum }_{i = 0.2}^{1.} {k}_{xx , i} ( 0.2 \leq {P}_{0} \leq 1.2 ) \\ {\sum }_{i = 1.1}^{1.5} {k}_{xx , i} ( 1.2 \leq {P}_{0} \leq 1.5 )\end{matrix} \qquad ( 2 )$$

For estimation of cutting force coefficients of the tool, a set of cutting experiments are conducted at different feed rates, with constant immersion and axial depth of cut. The average forces per tooth period are measured in terms of x, y and z directions. To avoid the influence of runout on the measurements, the total force per spindle revolution is collected and divided by the number of teeth on the tool. The tests were conducted with the hybrid tool with offset values 0 mm, 1.0 mm, 1.5 mm (the stiffness and damping ratio for offsets 0.5 and 1.0 mm were quite close, therefore offset 0.5 mm was not taken into consideration). When full-immersion conditions are applied, the average forces per tooth period are obtained as described in literature (Altintas Y (2012) Manufacturing Automation, Cambridge University Press):

$${\overline{F}}_{x} = - \frac{Na}{4} {K}_{r c} f - \frac{Na}{π} {K}_{r e} , \qquad ( 3 )$$

$${\overline{F}}_{y} = + \frac{Na}{4} {K}_{tc} f + \frac{Na}{π} {K}_{te} ,$$

$${\overline{F}}_{z} = + \frac{Na}{π} {K}_{a c} f + \frac{Na}{2} {K}_{a e} .$$

The average cutting forces can be expressed by a linear function of feed rate f (mm/rev/tooth) and an offset contributed by the edge forces as follows,

$${\overline{F}}_{q} = \overline{{F}_{q c}} f + \overline{{F}_{q e}} ( q = x , y , z ) \qquad ( 4 )$$

The average forces at each feed rate are measured, and the cutting edge components (F̅_̅{̅q̅c̅}̅, F̅_̅{̅q̅e̅}̅) are estimated by a linear regression of the data. Finally, the cutting force coefficients are evaluated from equations (3) and (4) as follows:

$${K}_{tc} = \frac{4 \overline{{F}_{y c}}}{Na} , {K}_{te} = \frac{π \overline{{F}_{y e}}}{Na} , \qquad ( 5 )$$

$${K}_{r c} = \frac{- 4 \overline{{F}_{x c}}}{Na} , {K}_{r e} = \frac{- π \overline{{F}_{x e}}}{Na} ,$$

$${K}_{a c} = \frac{π \overline{{F}_{z c}}}{Na} , {K}_{a e} = \frac{2 \overline{{F}_{z e}}}{Na} .$$

Average force plots in feed (x), normal (y) and axial (z) directions are shown in FIG. 23. The calculated cutting force coefficients are given in Table 5.

TABLE 5
Cutting force coefficients for hybrid tool

| Offset | | | |
|---|---|---|---|
| (P₀) | Cutting force coefficients | | |
| 0 mm | K_{tc} [N/mm²]: 686.51 | K_{rc} [N/mm²]: 3.93 | K_{ac} [N/mm²]: −975.57 |
| | Kₜₑ [N/mm²]: 28.51 | Kᵣₑ [N/mm²]: 28.61 | Kₐₑ [N/mm²]: 10.33 |
| 1 mm | K_{tc} [N/mm²]: 773.48 | K_{rc} [N/mm²]: 85.14 | K_{ac} [N/mm²]: −844.66 |
| | Kₜₑ [N/mm²]: 44.01 | Kᵣₑ [N/mm²]: 24.0 | Kₐₑ [N/mm²]: −22.26 |
| 1.5 mm | K_{tc} [N/mm²]: 747.85 | K_{rc} [N/mm²]: 297.07 | K_{ac} [N/mm²]: −2273.67 |
| | Kₜₑ [N/mm²]: 18.11 | Kᵣₑ [N/mm²]: 23.49 | Kₐₑ [N/mm²]: −15.64 |

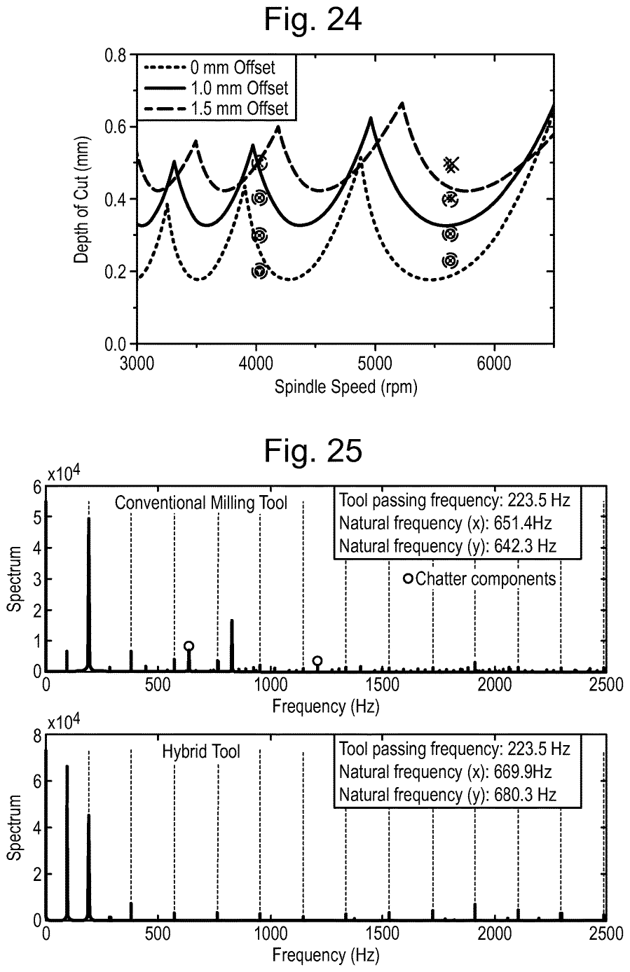

Based on the cutting force coefficients and calculated modal parameters, stability lobe diagrams (SLD) are generated for offsets 0 mm (conventional milling), 1 mm and 1.5 mm (hybrid tool), as shown in FIG. 24. It can be seen that as the compression offset increases, the stability lobes shift right and up, which shows higher damping and better cutting stability. Experiments were conducted to confirm the adequacy of the stability lobes diagram by detecting chatter for conventional milling and hybrid tools. Experiments were conducted at various conditions, shown as cross (confirmed chatter during experiments) and circles (confirmed stable cutting) on the stability lobe diagram in FIG. 24.

FFT analysis of the force data for depth of cut 0.3 mm and spindle speed 5735 rpm is shown in FIG. 25. Peaks for chatter frequency could be observed for conventional milling, whereas only the tool passing frequency harmonics were present for the hybrid tool. This confirms that the hybrid tool is suitable for chatter damping which should be extremely beneficial for achieving good surface finish and enhanced tool life.

### 4.3 Conclusions

These experiments confirmed that tools of the kind show in FIGS. 15 and 16 are effective in suppressing large amplitude roughness features and occurrence of chatter under aggressive conditions. The proposed tool could reduce the surface roughness by 20-84% on steel and aluminium, in comparison to that of a conventional milling tool. A chatter model was developed for the hybrid tool where modal parameters for the hybrid tool are determined using an impact hammer test while the SAG tool contacts the machine table. Stability lobes and chatter experiments proved that the hybrid tool is capable of chatter damping.

1. A shaping tool for shaping and polishing a workpiece, the shaping tool comprising:
a rigid shaping part for shaping the workpiece in use by movement of an outwardly facing surface of the rigid shaping part and a surface of the workpiece against each other so as to remove material from at least a part of the workpiece; and
a polishing surface biasable towards a first position in which said polishing surface protrudes relative to an adjacent region of the outwardly facing surface of the rigid shaping part, wherein the polishing surface is moveable to a second position in which the polishing surface lies level with said adjacent region of the outwardly facing surface of the rigid shaping part;
whereby, when the shaping tool is applied to a workpiece to remove material therefrom and polish the workpiece, the polishing surface, while moving against that part of the workpiece, is biased towards the first position so as to contact the part of the workpiece from which material was removed by the rigid shaping part thereby polishing that part of the workpiece.

2. The shaping tool of claim 1, further comprising a deformable polishing part comprising the polishing surface, the polishing surface being moveable between the first position and the second position by deformation of the deformable polishing part.

3. The shaping tool of claim 2, wherein the deformable polishing part comprises a cavity configured to receive, in use, a pressurised fluid for controlling the pressure between the polishing surface and the workpiece.

4. The shaping tool of claim 1, wherein the rigid shaping part is arranged to remove material from the workpiece when, in use, the rigid shaping part is placed in contact with the workpiece and the shaping tool is rotated about a rotational axis thereof.

5. The shaping tool of claim 1, wherein the polishing surface is arranged such that, as the shaping tool is rotated about the rotational axis, the polishing surface may, by the rotation of the shaping tool, be brought into contact with the part of the workpiece from which material was removed by the rigid shaping part.

6. The shaping tool of claim 1, wherein the polishing surface is arranged such that, as the shaping tool is translated along a tool path along which it removes material from the workpiece, the polishing surface may, by the translation of the shaping tool along the tool path, be brought into contact with the part of the workpiece from which material was removed by the rigid shaping part.

7. The shaping tool of claim 1, wherein the rigid shaping part is configured for shaping the workpiece by grinding, milling or turning.

8. The shaping tool of claim 1, wherein the polishing surface is configured for shape adaptive grinding.

9. The shaping tool of claim 1, wherein the polishing surface comprises a flexible support layer which carries abrasive particles arranged to contact the surface of the workpiece in use.

10. The shaping tool of claim 1, wherein the polishing surface and said adjacent region of the outwardly facing surface of the rigid shaping part are arranged concentric with one another.

11. The shaping tool of claim 10, wherein said adjacent region of the outwardly facing surface of the rigid shaping part is arranged outward relative to the polishing surface.

12. The shaping tool of claim 10, wherein the rigid shaping part is shaped to define an aperture and the polishing surface is arranged such that it protrudes from the aperture when in the first position.

13. The shaping tool of claim 1 wherein the polishing surface comprises an aperture arranged such that, when the shaping tool is rotated about an axis extending through the aperture, the entire polishing surface moves, due to the rotation of the tool, at a non-zero velocity.

14. The shaping tool of claim 1, wherein the outwardly facing surface of the rigid shaping part is shaped to define one or more grooves, wherein the polishing surface protrudes from the one of more grooves when in the first position and lies level with the regions of the outwardly facing surface adjacent to the grooves when in the second position.

15. The shaping tool of claim 1, wherein the rigid shaping part comprises one or more cutting elements each comprising a respective cutting edge arranged to remove material from the workpiece when placed in contact with the surface of the workpiece and moved against the surface of the workpiece, the outwardly facing surface comprising the cutting edges of the one or more cutting elements.

16. The shaping tool of claim 15, wherein the cutting elements are removably mounted on a tool body part configured to hold the cutting elements resiliently while removing material from the workpiece.

17. The shaping tool of claim 15, wherein the cutting elements are milling inserts.

18. The shaping tool of claim 15, wherein the cutting edges of the cutting elements are rounded.

19. The shaping tool of claim 15, wherein the polishing surface is a three-dimensional surface, preferably comprising a rounded edge region extending circumferentially around a central region of the polishing surface, wherein preferably the central region is substantially flat.

20. The shaping tool of claim 19, wherein the rounded edge is shaped to define one or more recessed areas, each cutting element being arranged inside one of the recessed areas such that when the polishing surface is in the second position, the part of the polishing surface adjacent to the recessed area lies level with the cutting edge of the cutting element arranged inside said recessed area.

21. A method of polishing a workpiece, the method comprising:
providing the shaping tool of claim 1 at a surface of the workpiece;
moving the rigid shaping part against the surface of the workpiece so as to remove material from at least a part of the workpiece; and
biasing the polishing surface towards the first position while in contact with the part of the workpiece from which material was removed by the rigid shaping part, while moving the polishing surface against that part of the workpiece, thereby polishing that part of the workpiece.

22. A method of polishing a workpiece, the method comprising:
moving a rigid shaping part against a surface of the workpiece while in contact with the workpiece so as to remove material from the workpiece, thereby forming at least one shaped region of the workpiece; and simultaneously:
applying a polishing surface of a deformable polishing part to one or more of the at least one shaped regions of the workpiece so as to polish said regions of the workpiece.

23. The method of claim 22, wherein moving of the rigid shaping part and applying the polishing surface simultaneously is provided by applying the method of claim 21.
